(19) United States
(12) Patent Application Publication
(10) Pub. No.: US 2025/0200720 A1
(43) Pub. Date: Jun. 19, 2025

(54) DETAIL PRESERVING DENOISER FOR SHORT EXPOSURE IMAGES

(71) Applicant: Samsung Electronics Co., Ltd., Suwon-si (KR)

(72) Inventors: Jing Li, Allen, TX (US); Pavan Madhusudanarao, Plano, TX (US); Zeeshan Nadir, Allen, TX (US); Hamid Rahim Sheikh, Allen, TX (US); John Seokjun Lee, Allen, TX (US)

(21) Appl. No.: 18/910,410

(22) Filed: Oct. 9, 2024

Related U.S. Application Data
(60) Provisional application No. 63/610,664, filed on Dec. 15, 2023.

(51) Int. Cl. G06T 5/60; G06T 5/50; G06T 5/70; H04N 23/81; H04N 23/84

(52) U.S. Cl. CPC G06T 5/60; G06T 5/50; G06T 5/70; G06T 2207/10024; G06T 2207/20081; H04N 23/81; H04N 23/84

(57) ABSTRACT

A method includes obtaining a noisy training image and a ground truth image and converting the noisy training image into a first plurality of color channels. The method also includes generating, using an artificial intelligence/machine learning (AI/ML)-based denoiser, denoised images from the first plurality of color channels. Each denoised image corresponds to a respective color channel of the first plurality of color channels. The method further includes generating a noisy ground truth image from the ground truth image and converting the noisy ground truth image into a second plurality of color channels. In addition, the method includes determining a loss based on a comparison between the denoised images and the second plurality of color channels and adapting weights of the AI/ML-based denoiser based on the loss determined based on the comparison between the denoised images and the second plurality of color channels.

### CROSS-REFERENCE TO RELATED APPLICATION AND PRIORITY CLAIM

This application claims priority under 35 U.S.C. § 119 (e) to U.S. Provisional Patent Application No. 63/610,664 filed on Dec. 15, 2023, which is hereby incorporated by reference in its entirety.

### TECHNICAL FIELD

This disclosure relates generally to image processing. More specifically, this disclosure relates to a detail preserving denoiser for short exposure images.

### BACKGROUND

Denoising is a useful or important operation in an image signal processing (ISP) pipeline or other image processing pipeline. Image noise is a phenomenon that is particularly noticeable in low light or short exposures, often manifesting as speckles or blur in an image. Image sensors introduce various types of noise. For example, shot noise refers to noise caused by the random nature of quantum interactions of photons with atoms of a sensor. Dark current noise refers to noise caused by thermally-generated electronics. Quantization noise refers to noise caused by inaccuracies in the process of “counting” electrical charges generated by incoming photons. Noise reduction algorithms can be employed to suppress these imperfections while preserving important image details. Techniques like spatial filtering, temporal noise reduction, and advanced denoising algorithms can be applied to reduce or minimize noise artifacts.

Conventionally, image denoising is done on single gray-scale images or demosaiced three-channel (such as red-green-blue or “RGB”) images. However, many times, there is a need to denoise images while in a raw image format prior to demosaicing. Noise in raw images tends to be less correlated and therefore less challenging to handle. In addition, raw images have three times fewer unknown pixel values compared to RGB images. Nevertheless, what makes denoising images in raw format difficult is that these images include pixels of different colors adjacent to each other. The exact arrangement of different color channels on a pixel grid depends on the color filter array (CFA) used in or with an image sensor.

With the trend towards high mega-pixel cameras, such as 200 megapixel (MP) cameras, the latest image sensors are now adopting more novel color filter array patterns, such as the Quad Bayer (Tetra) CFA pattern or the Nona and Hexa Deca (Tetra2) CFA pattern. These new color filter array patterns offer the flexibility of binning adjacent pixels in the same color channel for better imaging signal in low light or short exposure scenarios.

Denoising these non-Bayer raw images presents unique challenges because of the very large number of pixels that need to be processed and because of the increased pixel distance between pixels of different colors. Many different types of denoising techniques have been proposed, but most of those employing deep neural networks (DNNs) are trained for RGB images or traditional Bayer pattern raw images. Traditionally, in order to train a deep neural network on Bayer raw images, the practice has been to separate individual color phases into four-channel (such as red-green-green-blue or “RGGB”) images. However, a crucial shortcoming of such an approach is that separating out the sixteen channels in a Quad Bayer image results in aliasing artifacts due to spatial downsampling. FIGS. 17A and 17B and FIGS. 18A and 18B demonstrate example artifacts that can be caused due to noise in short exposure images. FIG. 17A and FIG. 18A are short exposure images, while FIG. 17B and FIG. 18B are corresponding long exposure images.

### SUMMARY

This disclosure relates to a detail preserving denoiser for short exposure images.

In a first embodiment, a method includes obtaining a noisy training image and a ground truth image and converting the noisy training image into a first plurality of color channels. The method also includes generating, using an artificial intelligence/machine learning (AI/ML)-based denoiser, denoised images from the first plurality of color channels, where each denoised image corresponds to a respective color channel of the first plurality of color channels. The method further includes generating a noisy ground truth image from the ground truth image and converting the noisy ground truth image into a second plurality of color channels. In addition, the method includes determining a loss based on a comparison between the denoised images and the second plurality of color channels and adapting weights of the AI/ML-based denoiser based on the loss determined based on the comparison between the denoised images and the second plurality of color channels. In other embodiments, a non-transitory machine readable medium contains instructions that when executed cause at least one processor to perform the method of the first embodiment.

In a second embodiment, an electronic device includes at least one processing device configured to train an AI/ML-based denoiser. To train the AI/ML-based denoiser, the at least one processing device is configured to obtain a noisy training image and a ground truth image and convert the noisy training image into a first plurality of color channels. To train the AI/ML-based denoiser, the at least one processing device is also configured to generate, using the AI/ML denoiser, denoised images from the first plurality of color channels, where each denoised image corresponds to a respective color channel of the first plurality of color channels. To train the AI/ML-based denoiser, the at least one processing device is further configured to generate a noisy ground truth image from the ground truth image and convert the noisy ground truth image into a second plurality of color channels. In addition, to train the AI/ML-based denoiser, the at least one processing device is configured to determine a loss based on a comparison between the denoised images and the second plurality of color channels and adapt weights of the AI/ML-based denoiser based on the loss determined based on the comparison between the denoised images and the second plurality of color channels.

In a third embodiment, a method includes obtaining a noisy captured image and denoising the noisy captured image using an AI/ML-based denoiser. The AI/ML-based denoiser is trained by obtaining a noisy training image and a ground truth image and converting the noisy training image into a first plurality of color channels. The AI/ML-based denoiser is also trained by generating, using the AI/ML-based denoiser, denoised images from the first plurality of color channels, where each denoised image corresponds to a respective color channel of the first plurality of color channels. The AI/ML-based denoiser is further trained by generating a noisy ground truth image from the ground truth image and converting the noisy ground truth image into a second plurality of color channels. In addition, the AI/ML-based denoiser is trained by determining a loss based on a comparison between the denoised images and the second plurality of color channels and adapting weights of the AI/ML-based denoiser based on the loss determined based on the comparison between the denoised images and the second plurality of color channels. In other embodiments, an electronic device includes at least one processing device configured to perform the method of the third embodiment. In still other embodiments, a non-transitory machine readable medium contains instructions that when executed cause at least one processor to perform the method of the third embodiment.

Any single one or any combination of the following features may be used with these embodiments. The noisy training image and the ground truth image may have an identical image color filter array (CFA) pattern, and the identical image CFA pattern may be one of: a Tetra CFA pattern, a Hexa-Deca CFA pattern, or a Nona CFA pattern. The loss may be determined using a linear combination of a mean absolute error (L1) loss, a multi-scale structural similarity loss, and an inter-channel loss. The noisy ground truth image may be generated by adding zero-mean Gaussian noise to the ground truth image. The noisy training image may include an exposure value zero (EV0) image or a lower exposure value image. The loss may be determined using a total variation loss between the denoised images and a corresponding color channel for the ground truth image. The noisy training image may include one of a plurality of noisy training images, each noisy training image may have a different proportion of noise.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration providing a detail-preserving denoiser for short exposure images processing in accordance with this disclosure;

FIG. 2 illustrates an example process of training a detail-preserving artificial intelligence/machine learning (AI/ML)-based denoising model for short exposure images in accordance with this disclosure;

FIG. 3 illustrates an example process of using a detail-preserving AI/ML-based denoising model in accordance with this disclosure;

FIG. 4 illustrates an example framework for training a detail-preserving AI/ML-based denoising model in accordance with this disclosure;

FIG. 5 illustrates an example architecture for employing a detail-preserving AI/ML-based denoising model in accordance with this disclosure;

FIG. 6 illustrates an example denoising network for detail-preserving AI/ML-based denoising in accordance with this disclosure;

FIG. 7 illustrates an example grouping of Tetra pixels for detail-preserving AI/ML-based denoising in accordance with this disclosure;

FIG. 8 illustrates an example of using a neighborhood of pixels for a corresponding pixel in a ground truth image to compute inter-total variance loss in accordance with this disclosure;

FIGS. 9A and 9B illustrate example pixel groupings for detail-preserving AI/ML-based denoising of CFA patterns other than Tetra in accordance with this disclosure;

FIGS. 10A and 10B illustrate an example addition of Gaussian noise with zero mean and a given standard deviation to a ground truth image in accordance with this disclosure;

FIGS. 11A and 11B illustrate an example detail-preserving denoising for short exposure images in accordance with this disclosure;

FIGS. 12A and 12B illustrate an example performance of detail-preserving denoising for short exposure images in accordance with this disclosure;

FIGS. 13A and 13B illustrate an example performance of detail-preserving denoising with noise regularization in accordance with this disclosure;

FIGS. 14A and 14B illustrate an example use of a Bayer denoising pipeline to denoise Tetra images;

FIGS. 15A and 15B illustrate an example of using a 4×4 Tetra kernel pattern as a single-channel input and separating each color out as a channel input;

FIG. 16A illustrates an example image (and an enlarged portion thereof) denoised using a Bayer denoiser by splitting the Tetra image into four Bayer images;

FIG. 16B illustrates an example image (and enlarged portion thereof) denoised by first separating each color into a separate channel; and

FIGS. 17A and 17B and FIGS. 18A and 18B illustrate example artifacts that can be caused due to noise in short exposure images.

### DETAILED DESCRIPTION

The figures, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

Currently, Quad Bayer sensors (also referred to as Tetra sensors in this disclosure) are gaining popularity. Tetra sensors offer the flexibility of extremely high-resolution captures (compared to, for example, Bayer sensors or other types of sensors) while also allowing for binning of pixels for low light conditions to increase the signal-to-noise ratio (SNR) by trading off resolution. Given the very high resolutions in Tetra sensors, captured image data can be noisier compared to typical (such as 12MP) Bayer sensors due to comparatively small pixel size.

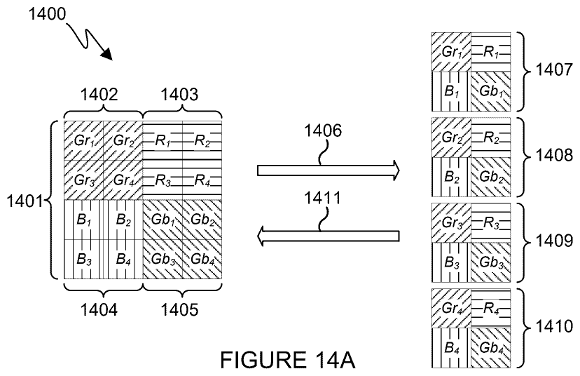

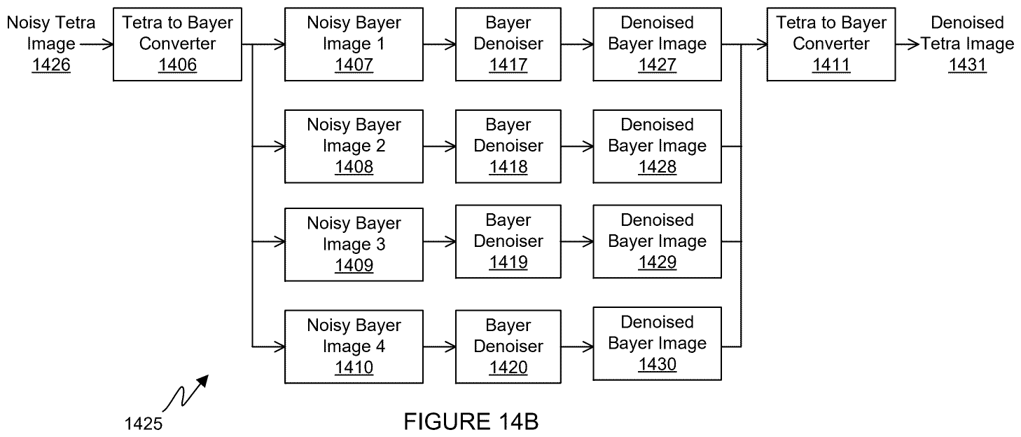

FIGS. 14A and 14B illustrate an example use of a Bayer denoising pipeline to denoise Tetra images. More specifically, FIG. 14A illustrates format conversions involved, and FIG. 14B diagrammatically illustrates a pipeline. An example Tetra kernel pattern 1401 is illustrated on the left side of the format conversions 1400 depicted in FIG. 14A and includes an arrangement of color filters on a 4×4 pixel array. In a Tetra sensor, each 4×4 pixel array 1401 includes multiple 2×2 arrays 1402-1405. Each 2×2 array 1402-1405 is clustered with the same color filter as shown in FIG. 14A. For example, each 4×4 Tetra kernel pattern 1401 includes one 2×2 array (such as 2×2 array 1404) having blue color filters, another 2×2 array (such as 2×2 array 1403) having red color filters, and two other 2×2 arrays (such as 2×2 array 1402 and 2×2 array 1405) having green color filters.

In order to use a Bayer denoising pipeline 1425 in FIG. 14B, each noisy Tetra image 1426 (composed of a plurality of 4×4 pixel arrays, including a pixel array for the 4×4 Tetra kernel pattern 1401) is subjected to a Tetra-to-Bayer converter 1406, thus resulting in four noisy Bayer images 1407-1410. The four noisy Bayer images 1407-1410 are respectively provided to four Bayer denoisers 1417-1420, which produce four denoised Bayer images 1427-1430. The four denoised Bayer images 1427-1430 are used by a Bayer-to-Tetra converter 1411 to generate a denoised Tetra image 1431.

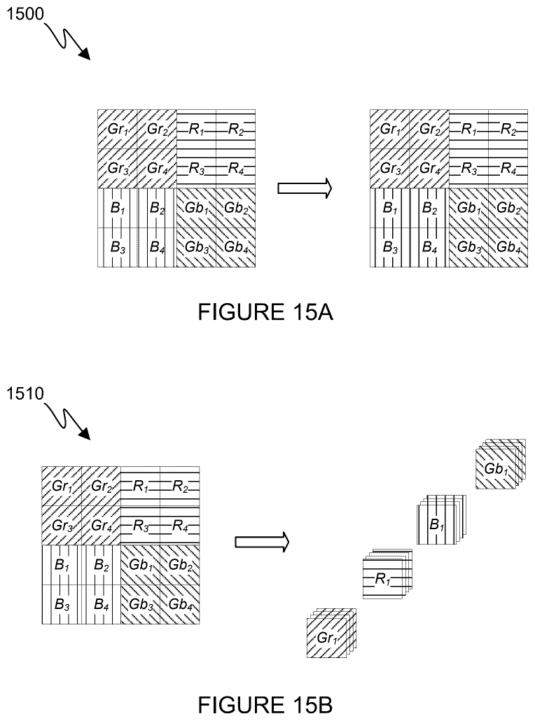

A Bayer denoising pipeline as illustrated by FIGS. 14A and 14B can be used to denoise Tetra images by breaking each Tetra image into four separate Bayer images (as illustrated in FIGS. 14A and 14B). In addition, existing techniques for training AI/ML networks for camera sensors also include using the entire Tetra pattern image as a single-channel input (such as shown in FIG. 15A) or separating out pixels in each Tetra pattern into separate channels (such as shown in FIG. 15B).

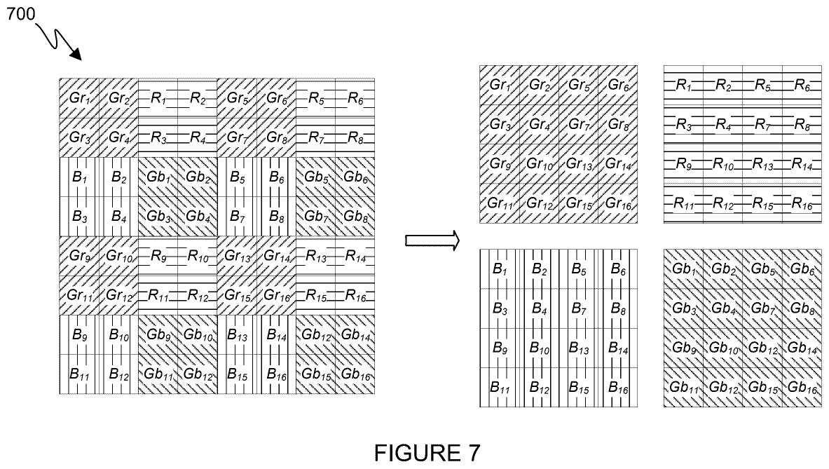

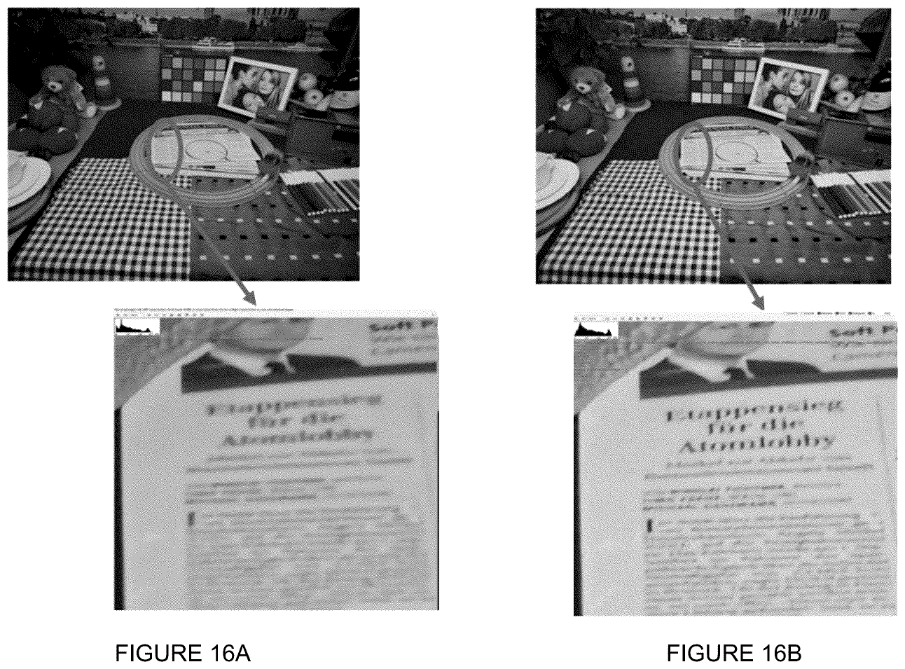

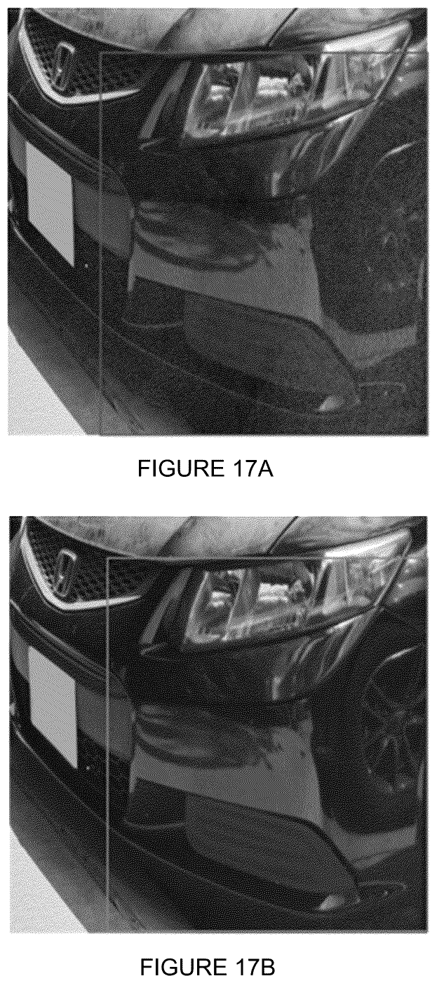

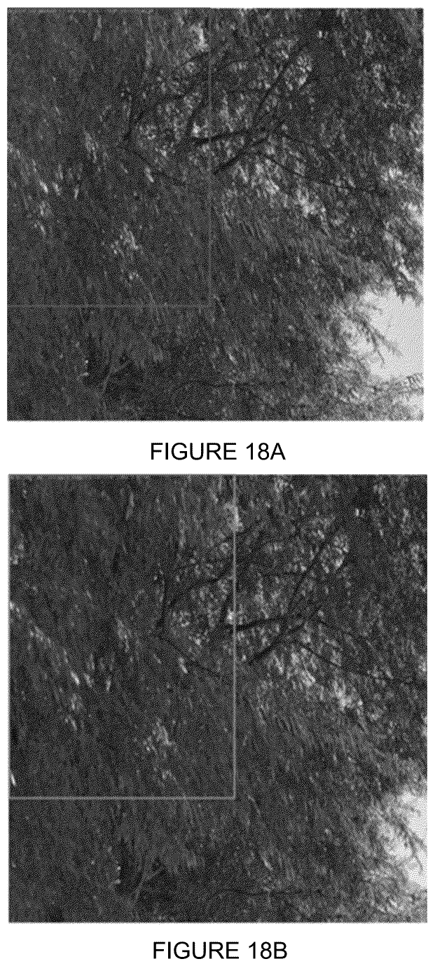

Using single-channel input and output (as in approach 1500 in FIG. 15A) can result in better image quality as opposed to using multiple channel inputs (for example, using four Bayer channels obtained from the single Tetra image). However, using a single channel input results in high computational cost because of the large memory requirements and consequently larger number of arithmetic operations that are needed. Consider the results shown in FIGS. 16A and 16B. FIG. 16A is an image (and an enlarged portion thereof) denoised using a Bayer denoiser by splitting the Tetra image into four Bayer images as shown in FIG. 14A and FIG. 14B, while FIG. 16B is an image (and an enlarged portion thereof) denoised by first separating each color four separate channels as shown in FIG. 7. However, using a Bayer denoiser as illustrated by FIGS. 14A and 14B can have low computational costs but can suffer from aliasing artifacts and therefore detail loss. FIG. 16A is the result of using a Bayer denoiser as illustrated in FIG. 14A.

The present disclosure provides an efficient, detail-preserving trained AI/ML-based denoiser for Tetra images or other images and a new and unique framework for training such a denoiser. Among other things, an optimal way of grouping pixels can be designed to achieve a desired tradeoff between image quality and inference speed/computation. Moreover, due to a large number of pixels per image, the trained AI/ML-based denoiser might ordinarily require a large amount of training data, which is hard to obtain. Therefore, a new inter-channel loss function is presented that can effectively regularize the AI/ML-based denoiser, causing the AI/ML-based denoiser to reduce or avoid noisy artifacts. Additionally, in order to avoid over-fitting, noise may be added to ground truth images during training of the AI/ML-based denoiser.

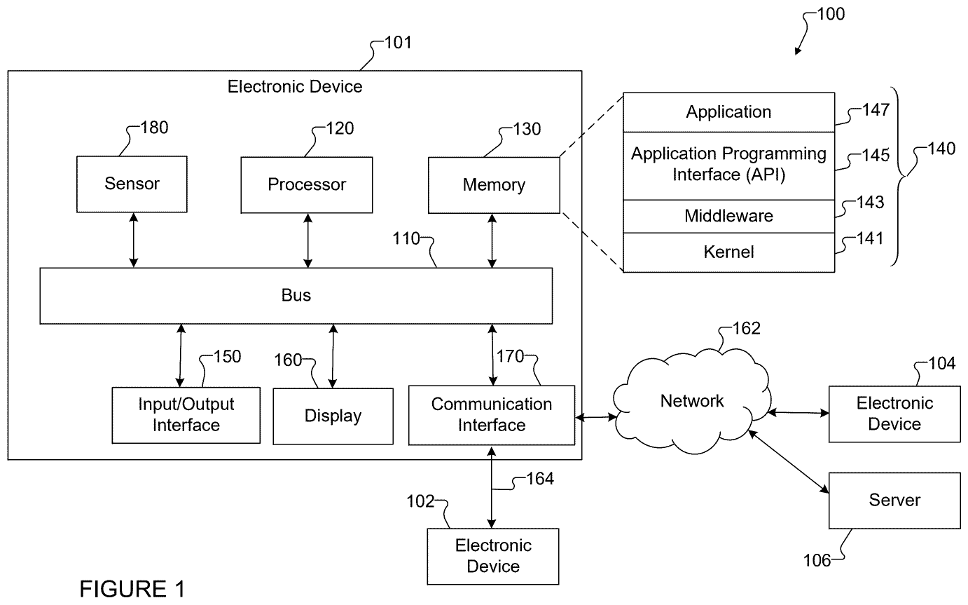

FIG. 1 illustrates an example network configuration 100 providing a detail-preserving denoiser for short exposure images processing in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to a detail-preserving AI/ML-based denoiser for short exposure images.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to a detail-preserving AI/ML-based denoiser for short exposure images. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to a detail-preserving AI/ML-based denoiser for short exposure images.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

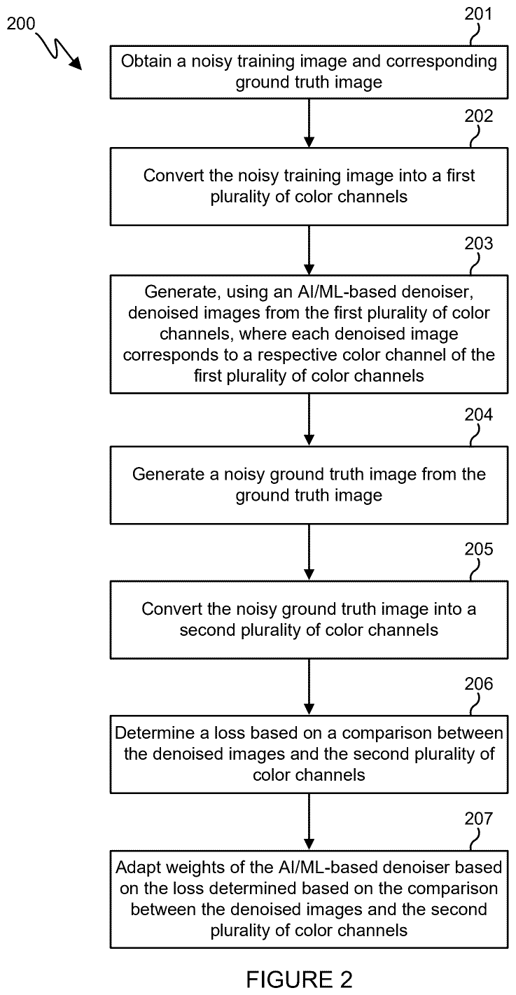

FIG. 2 illustrates an example process 200 of training a detail-preserving AI/ML-based denoising model for short exposure images in accordance with this disclosure. For case of explanation, the process 200 of FIG. 2 is described as being performed using the server 106 in the network configuration 100 of FIG. 1. However, the process 200 may be performed using any other suitable device(s) (such as the electronic device 101) and in any other suitable system(s).

As shown in FIG. 2, the process 200 begins with obtaining a noisy training image and a corresponding ground truth image (step 201). The noisy training image and the ground truth image may have an identical color filter array (CFA) pattern, such as a Tetra pattern, a Hexa-Deca pattern, or a Nona pattern. The noisy training image is converted into a first plurality of color channels (step 202). For example, a noisy Tetra image may be converted into four separate color channels. Note that the number of color channels here can vary based on the images being processed.

Using an AI/ML-based denoiser, denoised images are generated from the first plurality of color channels (step 203). Each denoised image corresponds to a respective color channel of the first plurality of color channels. A noisy ground truth image is generated from the ground truth image (step 204). For example, the noisy ground truth image may be generated by adding zero-mean Gaussian noise to the ground truth image. The noisy ground truth image is converted in a second plurality of color channels (step 205). For instance, if the noisy training image is converted into four color channels, the noisy ground truth image can also be converted into the four corresponding color channels. Again, note that the number of color channels here can vary based on the images being processed.

A loss is determined based on a comparison between the denoised images and the second plurality of color channels into which the noisy ground truth image was converted (step 206). For example, the loss may be determined using a linear combination of a mean absolute error (L1) loss, a multi-scale structural similarity loss, and an inter-channel loss, which can constitute a total variation loss between each of the denoised images and a corresponding color channel for the ground truth image. Weights of the AI/ML-based denoiser are adapted based on the loss determined by the comparison of the denoised images and the second plurality of color channels (step 207). In some cases, noise-based regularization to control overfitting to the training data can be used to produce superior weight adaptation.

Although FIG. 2 illustrates one example of a process 200 of training a detail-preserving AI/ML-based denoising model, various changes may be made to FIG. 2. For example, while shown as a series of steps, various steps in FIG. 2 could overlap, occur in parallel, occur in a different order, or occur any number of times (including zero times).

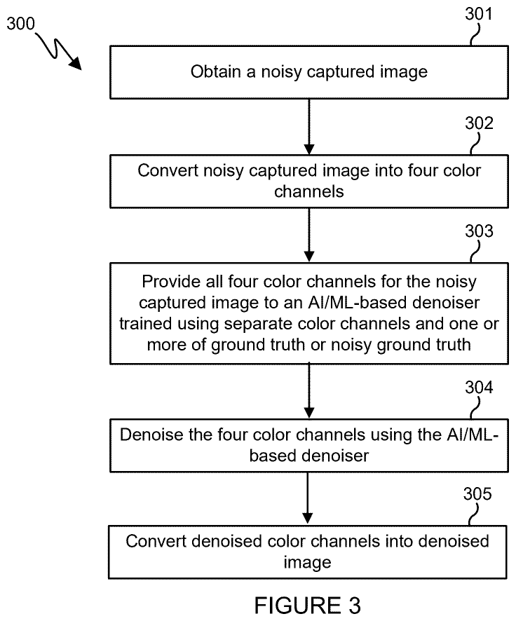

FIG. 3 illustrates an example process 300 of using a detail-preserving AI/ML-based denoising model in accordance with this disclosure. For case of explanation, the process 300 of FIG. 3 is described as being performed using the electronic device 101 in the network configuration 100 of FIG. 1. For example, the process 300 may be performed by the electronic device 101 using an AI/ML model that is trained using the process 200 of FIG. 2. However, the process 300 may be performed using any other suitable device(s) and in any other suitable system(s).

As shown in FIG. 3, the process 300 begins with obtaining a noisy captured image (step 301). For example, a short exposure image or other image may be captured using one or more imaging sensors 180 of the electronic device 101. The noisy captured image is converted from a CFA pattern into a plurality of color channels (step 302). As a particular example, the noisy captured image may be converted into four color channels. Examples of suitable color channel pixel groupings are depicted and described in connection with FIGS. 7 and 9A-9B. In some cases, this step may be performed for a subblock of pixels within the noisy captured image, such as a 4×4 block of pixels for a Tetra CFA pattern, an 8×8 block of pixels for a Hexa-Deca CFA, or a 6×6 block of pixels for a Nona CFA pattern.

The color channels from the captured noisy image are provided to an AI/ML-based denoiser that was trained using the process 200 of FIG. 2 or a similar process (step 303). In some cases, the AI/ML-based denoiser may be trained using a loss function that is a linear combination of a mean absolute error (L1) loss, a multi-scale structural similarity loss, and an inter-channel loss. The color channels provided to the AI/ML-based decoder can be denoised by the AI/ML-based denoiser (step 304). In some cases, the denoised color channel(s) can represent a prediction (or inference) by the AI/ML based denoiser based on an inter-total variance loss that takes into account neighborhood pixels of other color channels within the captured noisy image. The denoised color channels are converted into a denoised image (step 305).

Although FIG. 3 illustrates one example of a process 300 of using a detail-preserving AI/ML-based denoising model, various changes may be made to FIG. 3. For example, while shown as a series of steps, various steps in FIG. 3 could overlap, occur in parallel, occur in a different order, or occur any number of times (including zero times).

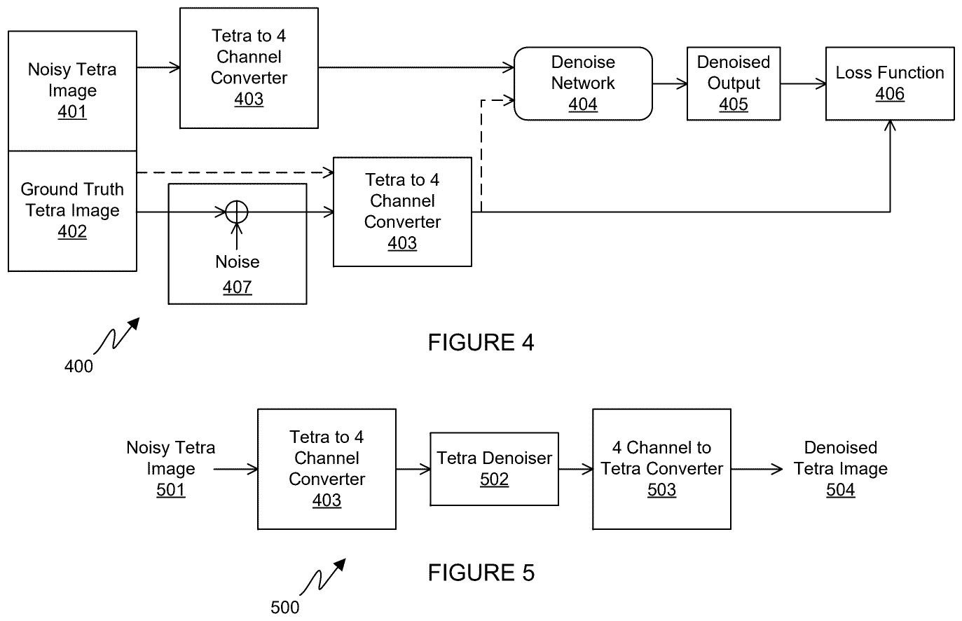

FIG. 4 illustrates an example framework 400 for training a detail-preserving AI/ML-based denoising model in accordance with this disclosure, and FIG. 5 illustrates an example architecture 500 for employing a detail-preserving AI/ML-based denoising model in accordance with this disclosure. For case of explanation, the framework 400 of FIG. 4 is described as being implemented using the server 106 in the network configuration 100 of FIG. 1, and the architecture 500 of FIG. 5 is described as being implemented using the electronic device 101 in the network configuration 100 of FIG. 1. However, the framework 400 and architecture 500 may be implemented using any other suitable device(s) and in any other suitable system(s).

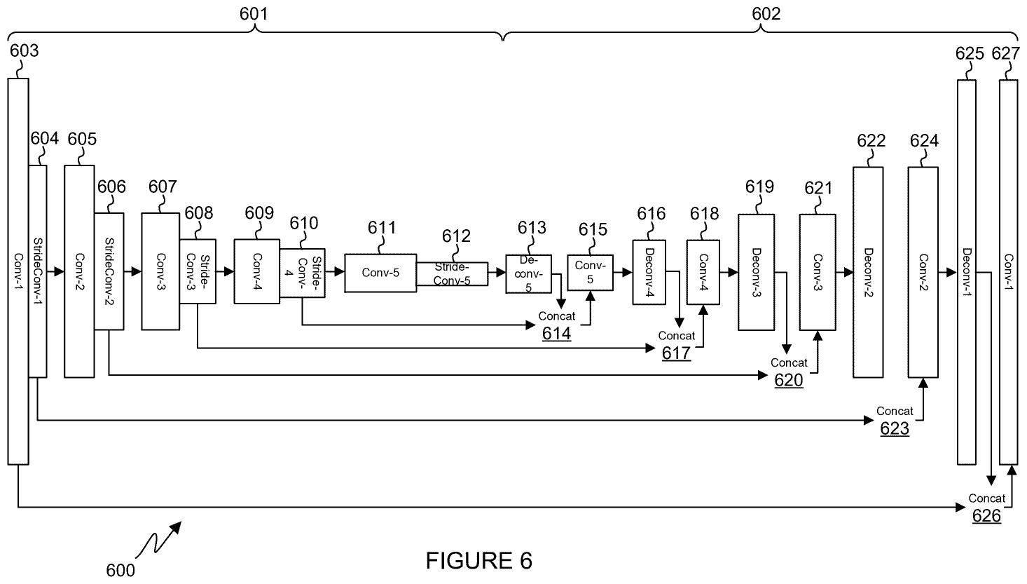

As shown in FIG. 4, this example training of a detail-preserving AI/ML-based denoising model uses, as inputs, a noisy Tetra image 401 and a corresponding ground truth Tetra image 402. The noisy Tetra image 401 is converted to a four-channel image using a converter 403. In some embodiments, the converter 403 implements a new technique to group Tetra pixels for deep neural network processing, where pixels of the same color space are grouped as a single channel (representing a spatial resolution trade-off with depth). Such grouping provides a good tradeoff between image quality and processing time. An example of the grouping of Tetra pixels that may be implemented by the converter 403 (both instances depicted in FIG. 4) is described below in connection with FIG. 7. The four-channel output of the converter 403 is provided to a denoise network 404. In some cases, the denoise network 404 may be a deep neural network (DNN) or other AI/ML model, such as one having the structure and operation described below in connection with FIG. 6. The denoise network 404 produces a denoised output 405.

The framework 400 may also employ a new inter-channel loss function 406 to preserve better details while controlling noise. Instead of using total variation loss over the predicted output, total variation loss between the predicted denoised output 405 and the ground truth Tetra image 402 may be utilized, which has a regularizing effect. Also, in some cases, noise-based regularization 407 can be employed to control overfitting to the training data. Robust regularization may be advantageous given the limited amount of training data.

Accordingly, noise may be added to the ground truth Tetra image 402 by the noise-based regularization 407. The noise-based regularization 407 may, for example, add zero-mean Gaussian noise to the ground truth Tetra image 402. Adding noise to the ground truth Tetra image 402 has the effect of increasing the variance in the data and the generalizability of the resulting model. The loss function 406 compares corresponding color channels for the ground truth image and the denoised image in determining total variation loss. In some embodiments, the loss function 406 may implement a linear combination of a mean absolute error (L1) loss, a multi-scale structural similarity loss, and an inter-channel loss.

Note that multiple training data pairs are used to train the denoise network 404. For example, both the noisy Tetra image 401 (such as EV-2 IN) and the ground truth Tetra image 402 (such as EV0 GT) may form one training data pair, and the output of the noise-based regularization 407 (such as EV0 IN) and the ground truth Tetra image 402 (such as EV0 GT) may form another training data pair. This approach helps to ensure that the AI/ML-based denoiser produced by the framework 400 is able to handle both higher noise and medium noise inputs since the denoiser has been trained to map each of these inputs to a ground truth image. The ground truth Tetra image 402 and the output of the noise-based regularization 407 may be converted to the same four-channel pixel groupings as the output of the converters 403 in FIG. 4 for use by both the loss function 406 and training of the denoise network.

As shown in FIG. 5, the architecture 500 receives a noisy Tetra image 501 to be denoised. The received noisy Tetra image 501 is processed by the converter 403, which converts the noisy Tetra image 501 into four channels or groupings of pixels of the same color space. The groupings of pixels output by the converter 403 are provided to a denoiser 502, which represents the trained denoise network 404. The output of the denoiser 502 is supplied to a four channel-to-Tetra converter 503, which implements the converse operation of the converter 403. The output of the converter 503 is a denoised Tetra image 504.

Although FIG. 4 illustrates one example of a framework 400 for training a detail-preserving AI/ML-based denoising model and FIG. 5 illustrates one example of an architecture 500 for employing a detail-preserving AI/ML-based denoising model, various changes may be made to FIGS. 4 and 5. For example, while the examples of FIGS. 4 and 5 are described in the context of Tetra image CFA patterns, the same framework 400 and architecture 500 may be employed with other CFA patterns. For instance, the framework 400 and the architecture 500 may be implemented for a Hexa-Deca CFA pattern or a Nona CFA pattern. In some cases, identical CFA patterns may be used for both the noisy image and the ground truth image.

FIG. 6 illustrates an example denoising network 600 for detail-preserving AI/ML-based denoising in accordance with this disclosure. In some cases, the denoising network 600 shown in FIG. 6 may be employed as the denoise network 404 within the framework 400 of FIG. 4 and as the denoiser 502 within the architecture 500 of FIG. 5.

As shown in FIG. 6, this example of the denoise network 600 may have a U-net based architecture with skip connections. The denoise network 600 here includes an encoder 601 (or contracting path) and a decoder 602 (or expanding path). The encoder 601 includes convolutional layers and strided convolutional layers. Each convolutional layer applies a convolution operation to its input (such as a portion of an image or subarray of pixels from a color channel) and passes the result to the next layer. Each strided convolutional layer uses a filter with a step size (stride) corresponding to a number of pixels skipped in the convolution operation. The decoder 602 includes transpose convolutional layers (also referred to as “deconvolutional” or “up-convolutional” layers) and concatenation functions with skip connections. Transpose convolutions up-sample image data to recover spatial information, and skip connections are used to send image data directly from the contracting path to a corresponding level in the expanding path without passing through all intervening layers, allowing features to be preserved and avoid information loss as a result of the contracting path. For example, a feature map from a convolutional operation can be concatenated with image data from a skip connection.

In the example of FIG. 6, the encoder 601 for the denoising network 600 receives a noisy image and includes a first convolutional layer 603 paired with a first strided convolutional layer 604, a second convolutional layer 605 paired with a second strided convolutional layer 606, a third convolutional layer 607 paired with a third strided convolutional layer 608, a fourth convolutional layer 609 paired with a fourth strided convolutional layer 610, and a fifth convolutional layer 611 paired with a fifth strided convolutional layer 612. Each strided convolutional layer 604, 606, 608, 610, 612 may use any suitable stride.

The decoder 602 for the denoising network 600 in the example of FIG. 6 includes a fifth transpose convolutional layer 613, the output of which is concatenated 614 with the skip connection image data from the fourth strided convolutional layer 610 and provided as an input to a fifth convolutional layer 615. The output of the fifth convolutional layer 615 is received by a fourth transpose convolutional layer 616, the output of which is concatenated 617 with the skip connection image data from the third strided convolutional layer 608 and provided as an input to a fourth convolutional layer 618. The output of the fourth convolutional layer 618 is received by a third transpose convolutional layer 619, the output of which is concatenated 620 with the skip connection image data from the second strided convolutional layer 606 and provided as an input to a third convolutional layer 621. The output of the third convolutional layer 621 is received by a second transpose convolutional layer 622, the output of which is concatenated 623 with the skip connection image data from the first strided convolutional layer 604 and provided as an input to a second convolutional layer 624. The output of the second convolutional layer 624 is received by a first transpose convolutional layer 625, the output of which is concatenated 626 with the skip connection image data from the first convolutional layer 603 and provided as an input to a first convolutional layer 627. The output of the first convolutional layer 627 is a prediction of a denoised image.

In this disclosure, the denoising network 600 may operate sequentially on each color channel of a noisy Tetra image or other image for which pixel information has been grouped using a Tetra-to-four channel converter 403 or other converter. The output from each iteration of operation of the denoising network 600 can represent a single color channel of the denoised Tetra image or other denoised image. The complete denoised Tetra image or other complete denoised image can be formed by the converse pixel grouping of the four channel-to-Tetra converter 503 or other converter. In other cases, separate instances of the denoising network 600 may be implemented for each of the color channels, and the separate instances of the denoising network 600 may operate in parallel.

Although FIG. 6 illustrates one example of a denoising network 600 for detail-preserving AI/ML-based denoising, various changes may be made to FIG. 6. For example, a denoising network may implement any other suitable AI/ML-based architecture. Moreover, the depth, width, and sizes of different filters or layers can have any suitable values, such as those determined experimentally and chosen according to computational budgets.

FIG. 7 illustrates an example grouping of Tetra pixels for detail-preserving AI/ML-based denoising in accordance with this disclosure. In some cases, the pixel grouping 700 may form the basis of operation for the converter(s) 403 within the framework 400 of FIG. 4 and for the converter 403 and converter 503 within the architecture 500 of FIG. 5. Also, in some cases, the pixel grouping 700 may be employed by the denoising network 600 of FIG. 6.

As shown in FIG. 7, the proposed Tetra-to-four channel converter(s) 403 may group channels based on colors as input to the denoising network 600. The pixel grouping 700 represents a new technique for grouping Tetra pixels for deep neural network processing or other processing. Here, for example, the right side of FIG. 7 is treated as input, and the left side of FIG. 7 is treated as output for the converter(s) 403. The converse operation can be performed according to the groupings shown in FIG. 7 by the converter 503. The Tetra CFA pattern (illustrated on the left side of FIG. 14A)—namely four colors Gr, R, B, and Gb—are sensed in a 4×4 array of pixels. In the pixel grouping 700, an 8×8 grid of pixels from the Tetra CFA pattern may be treated as a single Tetra cell (the left side of FIG. 7). The pixel grouping 700 can be used to generate four channel patterns (Gr, R, B, and Gb), each an aggregated 4×4 grid of a given color (the right side of FIG. 7). As discussed above, grouping pixels of the same color as a single channel (trading off spatial resolution with depth) may provide a good balance between image quality and processing time.

Although FIG. 7 illustrates one example of a grouping of Tetra pixels for detail-preserving AI/ML-based denoising, various changes may be made to FIG. 7. For example, while the use of a Tetra CFA pattern is shown here, other CFA patterns may be used.

Referring back to FIG. 4, in some embodiments, the loss function 406 may be based on a new inter-channel loss function to preserve better details while controlling noise. Stated differently, the loss function 406 may be implemented as an inter-channel total variance loss function to improve image details while suppressing artifacts. In particular embodiments, the loss function 406 may be expressed as follows.

$${L}_{all} = {w}_{1} * {L}_{1} + {w}_{2} * {L}_{SSIM} + {w}_{3} * {L}_{ICL} .$$

Here, the term Lau combines three terms (L1 loss L₁, multi-scale structural similarity (MS-SSIM) loss L_{SSIM}, and inter-channel loss L_{ICL}) with three associated weights (w₁, w₂, and w₃). Once a loss is determined using the loss function Lₐₗₗ, regular backpropagation or other technique may be used for the training process. The inter-channel loss L_{ICL} is discussed in further detail below.

In one approach, given a pair of input and ground truth images, the input image is fed into a network, and the loss between the output image and the ground truth image are determined Backpropagation or other technique is used to adjust the weights of the network based on the loss. Note that the loss here can be determined using any number of pairs of input and ground truth images. Therefore, the loss function in this approach is a combination of L1 norm and MS-SSIM losses. To improve image details, the inter-total variance loss function L_{ICL} may also be used. The loss L_{ICL} can be computed between the output and ground truth images on each color channel.

Based on total variance loss, it may be assumed that neighborhood pixels are supposed to be similar. However, the loss function in the approach above suffers from a smoothing effect. In order to overcome this, inter-total variance loss L_{ICL} may use a neighborhood of pixels of each corresponding pixel in the ground truth image, which could be expressed in the following manner.

$${L}_{ICL} = \frac{1}{N} {\sum }_{S ∈ \{ R , Gr , B , Gb \}} {\sum }_{k = 0}^{N / 4} {\sum }_{j = i + 1}^{4} {\sum }_{i = 1}^{3} \vert {\hat{Y}}_{4 k + i} - {Y}_{4 k + j} \vert ,$$

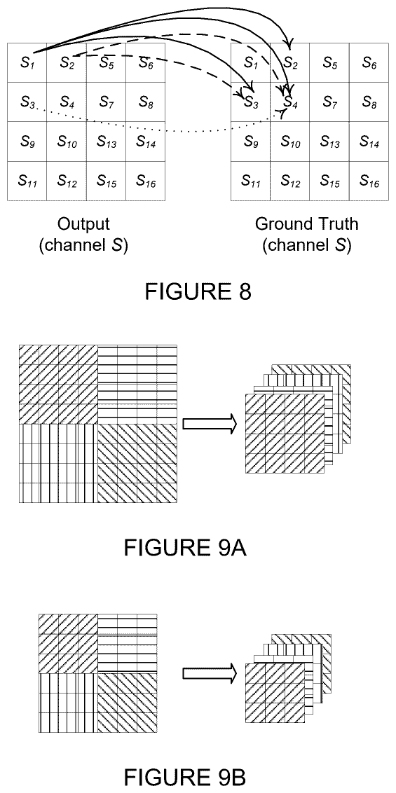

Here, N represents the number of pixels for each channel (N=16 in the example of FIG. 7), S represents the channel index for one of the channels (Gr, R, B, and Gb in the example of FIG. 7), Ŷ represents the output of the denoising network 600, Y represents the ground truth for the same channel as considered for Ŷ, k represents the index of the four-pixel group, and i and j represent the pixel index within the four-pixel group. FIG. 8 illustrates an example of using a neighborhood of pixels for a corresponding pixel in a ground truth image to compute inter-total variance loss L_{ICL} in accordance with this disclosure.

It is noted that although FIG. 7 depicts an example grouping of Tetra pixels for detail-preserving AI/ML-based denoising and that the discussion above of the loss function 406 relates to a Tetra denoiser, a similar approach can be used for other kernel patterns. For example, FIGS. 9A and 9B illustrate example pixel groupings for detail-preserving AI/ML-based denoising of CFA patterns other than Tetra in accordance with this disclosure. Other aspects shown in FIGS. 7 and 8 may be similar for other kernel patterns. In FIG. 9A, a 16×16 Hexa-Deca CFA pattern is converted to four channels of 4×4 pixel groupings. In FIG. 9B, a 9×9 Nona CFA pattern is converted to four channels of 3×13 pixel groupings. Note, however, that these CFA patterns are examples only and that other CFA patterns may be used.

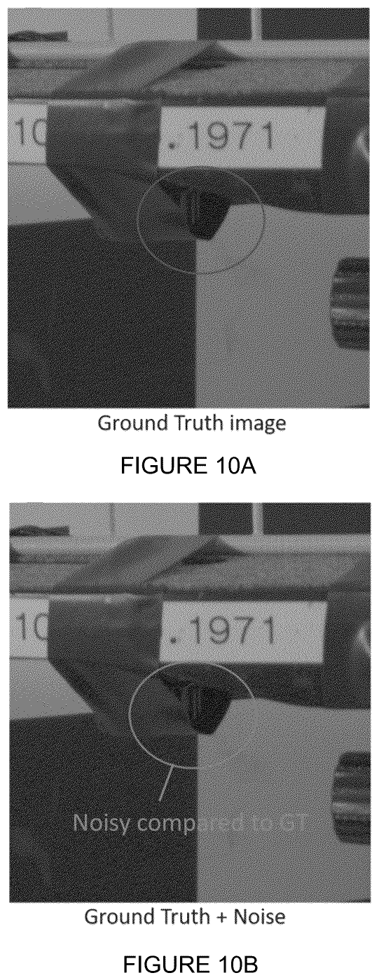

Referring back to FIG. 4, the noise-based regularization 407 can be used to control overfitting to the training data, and the framework 400 may add noise to the ground truth Tetra image 402 to regularize the trained model and improve details in denoised output image. FIGS. 10A and 10B illustrate an example addition of Gaussian noise with zero mean and a given standard deviation in accordance with this disclosure.

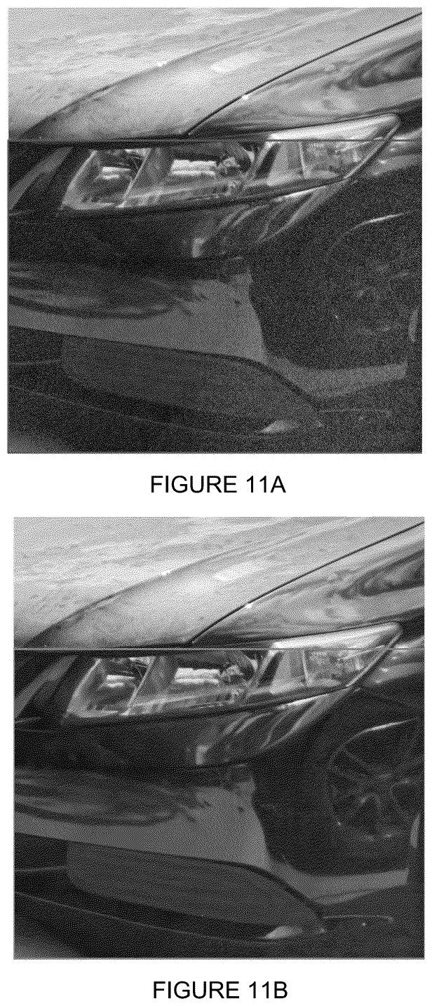

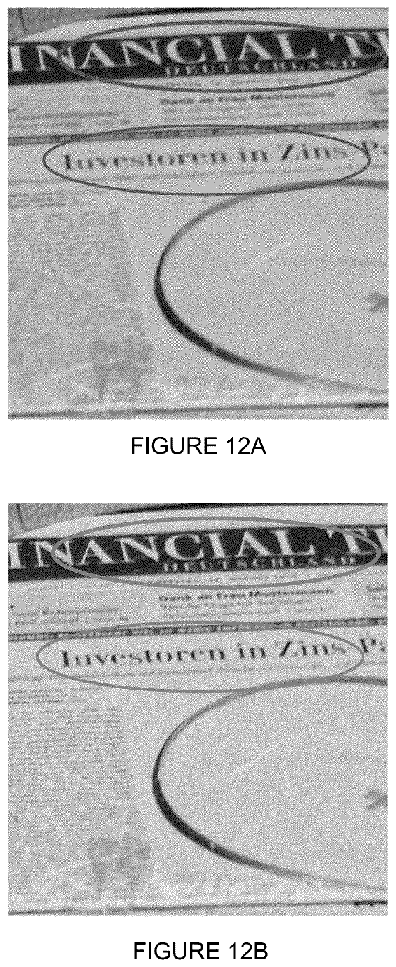

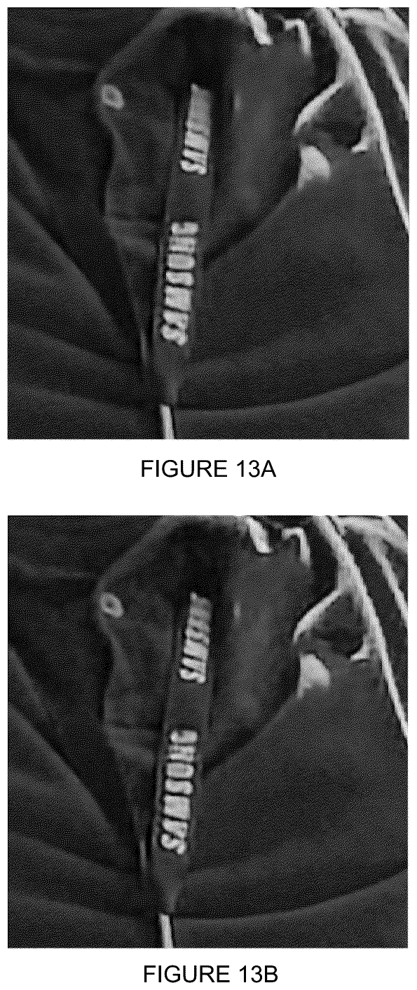

FIGS. 11A and 11B illustrate an example detail-preserving denoising for short exposure images in accordance with this disclosure. FIG. 11A is a noisy image, while FIG. 11B is the resultant denoised image that is produced using a denoiser trained according to the present disclosure. FIGS. 12A and 12B illustrate an example performance of detail-preserving denoising for short exposure images in accordance with this disclosure. FIG. 12A is a noisy image denoised by a regular Bayer denoiser, while FIG. 12B is the same noisy image denoised image that is produced using a Tetra denoiser trained according to the present disclosure. FIGS. 13A and 13B illustrate an example performance of detail-preserving denoising with noise regularization in accordance with this disclosure. FIG. 13A is a noisy image denoised using a Tetra denoiser trained without noise regularization, while FIG. 13B is the same noisy image denoised using a Tetra denoiser trained with noise regularization according to the present disclosure.

Although FIGS. 11A through 13B illustrate examples of detail-preserving denoising and related performance, various changes may be made to FIGS. 11A through 13B. For example, images of scenes can vary widely, and FIGS. 11A through 13B do not limit the scope of this disclosure to any particular denoising or performance characteristics.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining a noisy training image and a ground truth image;
converting the noisy training image into a first plurality of color channels;
generating, using an artificial intelligence/machine learning (AI/ML)-based denoiser, denoised images from the first plurality of color channels, wherein each denoised image corresponds to a respective color channel of the first plurality of color channels;
generating a noisy ground truth image from the ground truth image;
converting the noisy ground truth image into a second plurality of color channels;
determining a loss based on a comparison between the denoised images and the second plurality of color channels; and
adapting weights of the AI/ML-based denoiser based on the loss determined based on the comparison between the denoised images and the second plurality of color channels.

2. The method of claim 1, wherein:
the noisy training image and the ground truth image have an identical image color filter array (CFA) pattern; and
the identical image CFA pattern is one of: a Tetra CFA pattern, a Hexa-Deca CFA pattern, or a Nona CFA pattern.

3. The method of claim 1, wherein determining the loss comprises using a linear combination of a mean absolute error (L1) loss, a multi-scale structural similarity loss, and an inter-channel loss.

4. The method of claim 1, wherein generating the noisy ground truth image comprises adding zero-mean Gaussian noise to the ground truth image.

5. The method of claim 1, wherein the noisy training image comprises an exposure value zero (EV0) image or a lower exposure value image.

6. The method of claim 1, wherein determining the loss comprises using a total variation loss between the denoised images and a corresponding color channel for the ground truth image.

7. The method of claim 1, wherein the noisy training image comprises one of a plurality of noisy training images, each noisy training image having a different proportion of noise.

8. An electronic device comprising:
at least one processing device configured to train an artificial intelligence/machine learning (AI/ML)-based denoiser;
wherein, to train the AI/ML-based denoiser, the at least one processing device is configured to:
obtain a noisy training image and a ground truth image;
convert the noisy training image into a first plurality of color channels;
generate, using the AI/ML-based denoiser, denoised images from the first plurality of color channels, wherein each denoised image corresponds to a respective color channel of the first plurality of color channels;
generate a noisy ground truth image from the ground truth image;
convert the noisy ground truth image into a second plurality of color channels;
determine a loss based on a comparison between the denoised images and the second plurality of color channels; and
adapt weights of the AI/ML-based denoiser based on the loss determined based on the comparison between the denoised images and the second plurality of color channels.

9. The electronic device of claim 8, wherein:
the noisy training image and the ground truth image have an identical image color filter array (CFA) pattern; and
the identical image CFA pattern is one of: a Tetra CFA pattern, a Hexa-Deca CFA pattern, or a Nona CFA pattern.

10. The electronic device of claim 8, wherein, to determine the loss, the at least one processing device is configured to use a linear combination of a mean absolute error (L1) loss, a multi-scale structural similarity loss, and an inter-channel loss.

11. The electronic device of claim 8, wherein, to generate the noisy ground truth image, the at least one processing device is configured to add zero-mean Gaussian noise to the ground truth image.

12. The electronic device of claim 8, wherein the noisy training image comprises an exposure value zero (EV0) image or a lower exposure value image.

13. The electronic device of claim 8, wherein, to determine the loss, the at least one processing device is configured to use a total variation loss between the denoised images and a corresponding color channel for the ground truth image.

14. A method comprising:
obtaining a noisy captured image; and
denoising the noisy captured image using an artificial intelligence/machine learning (AI/ML)-based denoiser, wherein the AI/ML-based denoiser is trained by:
obtaining a noisy training image and a ground truth image;
converting the noisy training image into a first plurality of color channels;
generating, using the AI/ML-based denoiser, denoised images from the first plurality of color channels, wherein each denoised image corresponds to a respective color channel of the first plurality of color channels;
generating a noisy ground truth image from the ground truth image;
converting the noisy ground truth image into a second plurality of color channels;
determining a loss based on a comparison between the denoised images and the second plurality of color channels; and
adapting weights of the AI/ML-based denoiser based on the loss determined based on the comparison between the denoised images and the second plurality of color channels.

15. The method of claim 14, wherein:
the noisy training image and the ground truth image have an identical image color filter array (CFA) pattern; and
the identical image CFA pattern is one of: a Tetra CFA pattern, a Hexa-Deca CFA pattern, or a Nona CFA pattern.

16. The method of claim 14, wherein determining the loss comprises using a linear combination of a mean absolute error (L1) loss, a multi-scale structural similarity loss, and an inter-channel loss.

17. The method of claim 14, wherein generating the noisy ground truth image comprises adding zero-mean Gaussian noise to the ground truth image.

18. The method of claim 14, wherein the noisy training image comprises an exposure value zero (EV0) image or a lower exposure value image.

19. The method of claim 14, wherein determining the loss comprises using a total variation loss between the denoised images and a corresponding color channel for the ground truth image.

20. The method of claim 14, wherein the noisy training image comprises one of a plurality of noisy training images, each noisy training image having a different proportion of noise.
